(19) United States
(12) Patent Application Publication
(10) Pub. No.: US 2005/0092117 A1
(43) Pub. Date: May 5, 2005

(54) Gear assembly

(75) Inventor: Zhou Yajun, Taoyuan (TW)

Correspondence Address: Richard P. Berg, Esq.;c/o LADAS & PARRY, Suite 2100, 5670 Wilshire Boulevard, Los Angeles, CA, 90036-5679, US

(73) Assignee: BENQ CORPORATION

(21) Appl. No.: 10/977,656

(22) Filed: Oct. 28, 2004

(30) Foreign Application Priority Data
Oct. 29, 2003 (TW) 092130139

(51) Int. Cl. F16H 61/00

(52) U.S. Cl. 74/413

(57) ABSTRACT

The invention provides a gear assembly assembled onto a plane on which a first shaft and a second shaft are provided. The gear assembly according to the invention includes a first gear and a second gear. The first gear is mounted onto the first shaft. The second gear is mounted onto the second shaft, and meshes with the first gear. In particular, the height of the first gear is higher than that of the second shaft. The gear assembly according to the invention can prevent from gear teeth cracks induced during assembly.

### BACKGROUND OF THE INVENTION

1. Field of the Invention

This invention relates to a gear assembly. More particularly, the gear assembly according to this invention can prevent itself from gear teeth cracks induced during assembly.

2. Description of the Prior Art

Office machines must be assembled with various gear assemblies to drive other components.

However, the gear teeth cracks as shown in FIG. 1 occur frequently in a gear assembly including two adjacent gears. The gear teeth cracks will be described below.

As shown in FIG. 1A, a gear assembly 10, consisting of a first gear 12 and a second gear 14, is assembled onto a plane 20. The plane 20 is generally provided by a circuit board if the plane is in an office machine. A first shaft 22 and a second shaft 24 are also provided on the plane 20. Finally, the first gear 12 is mounted onto the first shaft 22, the second gear 14 is mounted onto the second shaft 24, and the first gear 12 meshes with the second gear 14.

The assembling of the gear assembly shown in FIG. 1A is shown in FIG. 1B. Generally, the first gear 12 is first mounted onto the first shaft 22, and then the mounting procedure of second gear 14 proceeds. Because the height of the first gear 12 (h1) is less than the height of the second shaft 24 (h2), as shown in FIG. 1A, the condition as shown in FIG. 1B is often induced. The second gear 14 is directly assembled onto the second shaft 24, but the second gear 14 doesn't necessarily mesh with the first gear 12. If the second gear 14 is assembled by force when the second gear 14 doesn't mesh with the first gear 12, slight crevices 142 or attritions for shape of the gear are easily induced in the tooth of the second gear 14 (or in the tooth of the first gear 12) and the gear teeth cracks are formed. More serious injuries such as damages for shape of the gear will possibly come up during the operation of the gear with gear teeth cracks and will further make the whole system operate unsuccessfully or even shut down.

With the current trend of expanding an office machine to a multi-functional machine, the inner gears applied to office machines must be considered toward the directions such as small sizes or forming of light materials (for example, polymer material). It's obvious that undesired gear teeth cracks would be the main problem, which shut office machines.

Besides, to change the rotational speed of other gears, some gears are compound gears. The second gear 14 as shown in FIG. 1A is a compound gear consisting of an upper gear 16 and a lower gear 18. The second gear 14 as shown in FIG. 1A is a typical compound gear, namely, the upper gear 16 is coaxial with and stacks tightly on the lower gear 18. The outer diameter of the upper gear 16 (d1) is smaller than the outer diameter of the lower gear 18 (d2). If the second gear 14 is a compound gear as shown in FIG. 1A, the height of the lower gear itself (d2) is less than the height of the whole second gear 14. Relatively, the strength of the lower gear is smaller. Once the lower gear collides with the first gear 12, the probability of having gear teeth cracks for the lower gear rises relatively.

When the first gear 12 is formed of a metal material and the second gear 14 is a typical compound gear formed of a polymer material, there must be more deliberate solutions for the design of the gear assembly 10 and corresponding assembling procedures.

### SUMMARY OF THE INVENTION

Accordingly, one main purpose of this invention is providing a gear assembly. More particularly, the gear assembly according to this invention can prevent itself from gear teeth cracks induced during assembly.

A gear assembly, according to one preferred embodiment of the invention, is assembled onto a plane on which a first shaft and a second shaft are provided. The gear assembly including a first gear and a second gear. The first gear is mounted onto the first shaft. The second gear is mounted onto the second shaft and meshes with the first gear. The height of the first gear is higher than the height of the second shaft. The second gear has bottom surface and a cylindrical hole adapted to the second shaft. During the assembling process of the gear assembly, the mounting procedure of the second gear follows the mounting procedure of the first gear. The mounting procedure of the second gear includes the following steps: (a) holding the second gear such that the bottom surface of the second gear is over the second shaft; (b) moving the held second gear forward the mounted first gear such that the second gear partially meshes with the mounted first gear; (c) adjusting the position of the second gear meshing with the first gear such that the second shaft is inserted into the cylindrical hole of the second gear; and (d) moving the second gear forward the plane to complete the mounting of the second gear onto the second shaft.

The advantage and spirit of the invention may be understood by the following recitations together with the appended drawings.

### BRIEF DESCRIPTION OF THE APPENDED DRAWINGS

FIG. 1A and FIG. 1B show the gear assembly 10 consisting of two adjacent gears according to prior arts and the assembling procedure of the gear assembly. The gear teeth cracks easily induced during the assembling procedure are also signified in the figure.

FIG. 2A through FIG. 2E show the gear assembly 30 according to one preferred embodiment of the invention and the assembling procedure of the gear assembly.

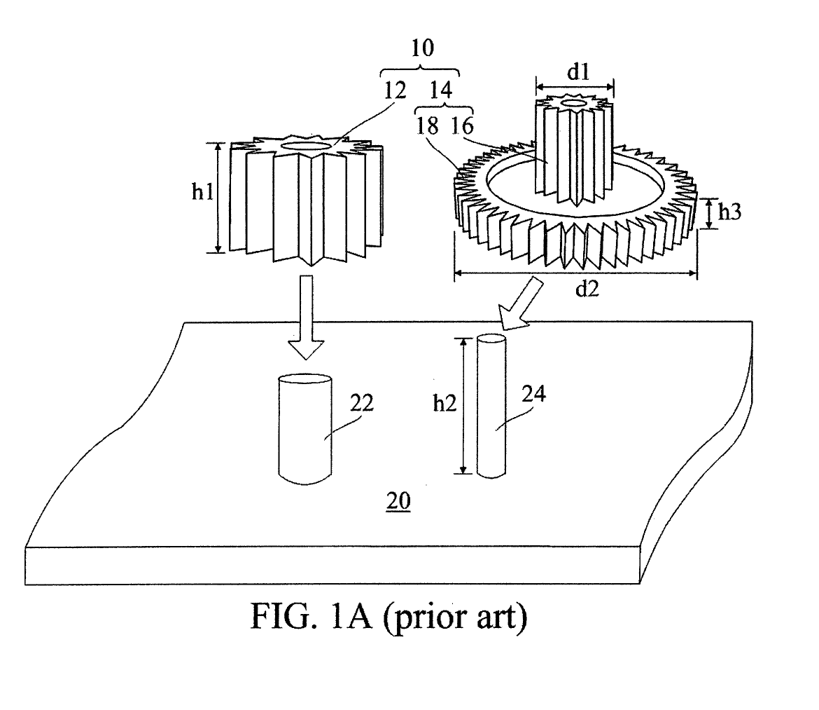

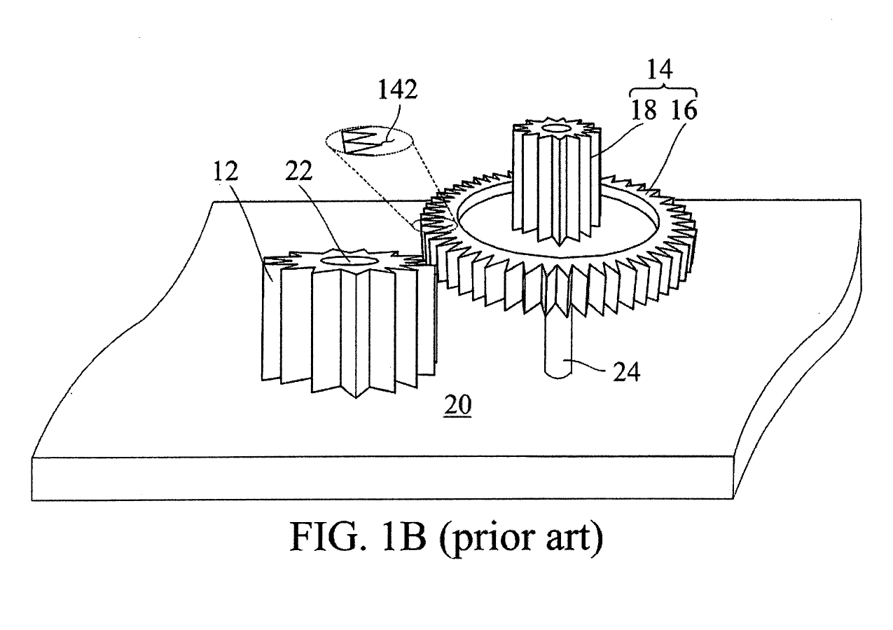

### DETAILED DESCRIPTION OF THE INVENTION

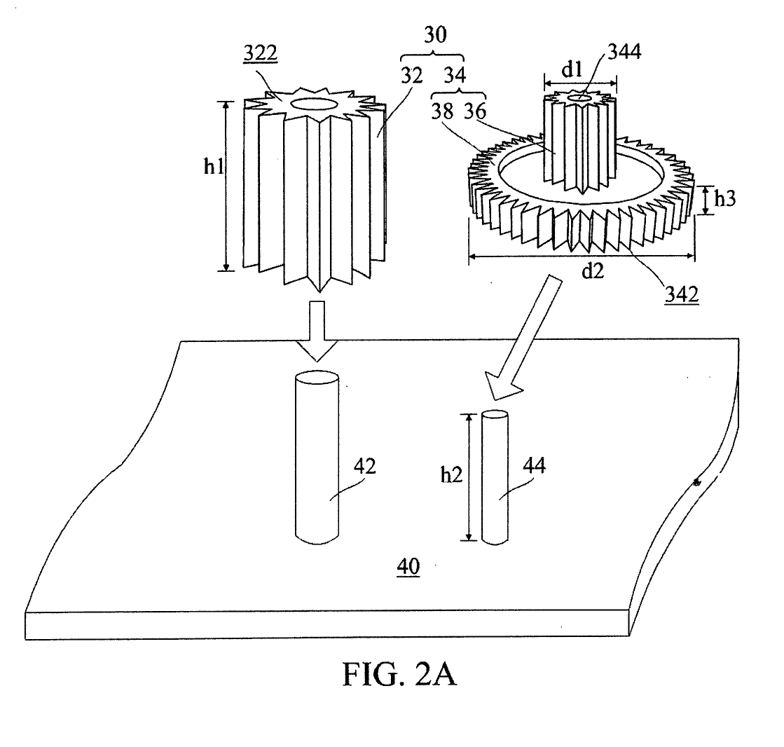

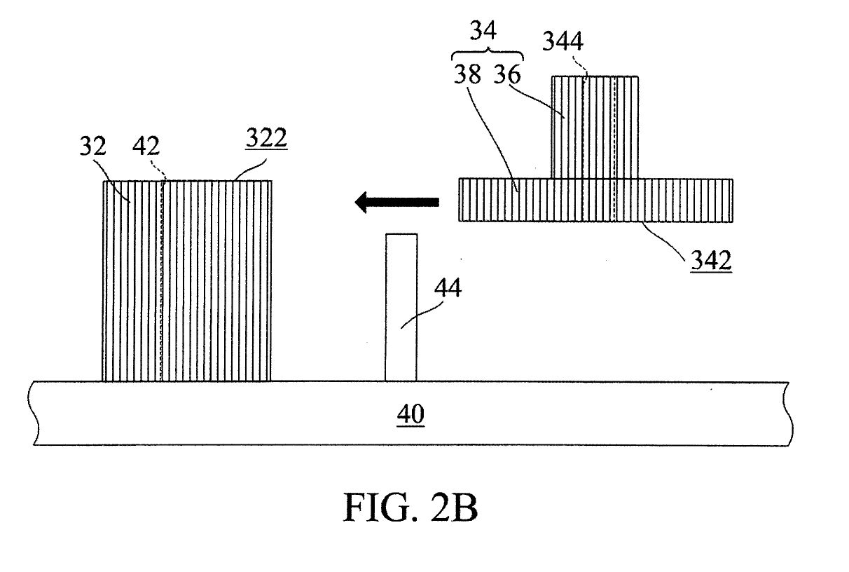

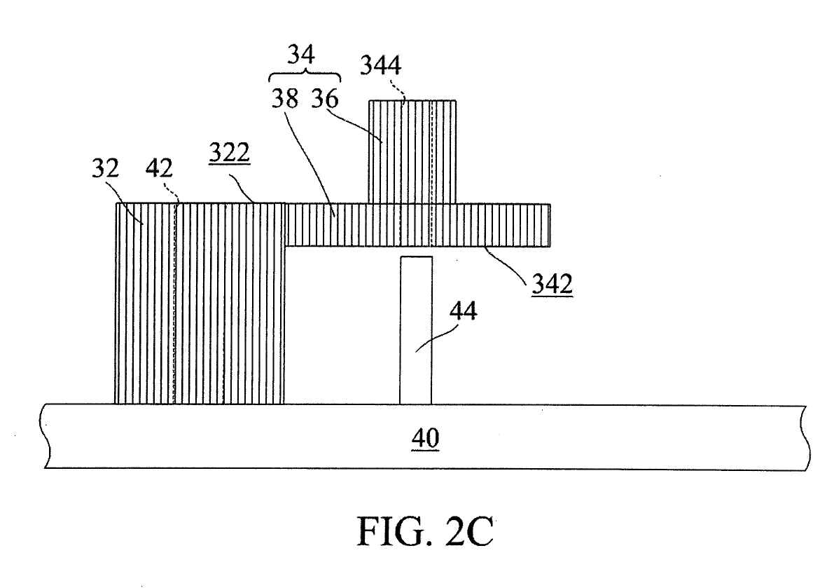

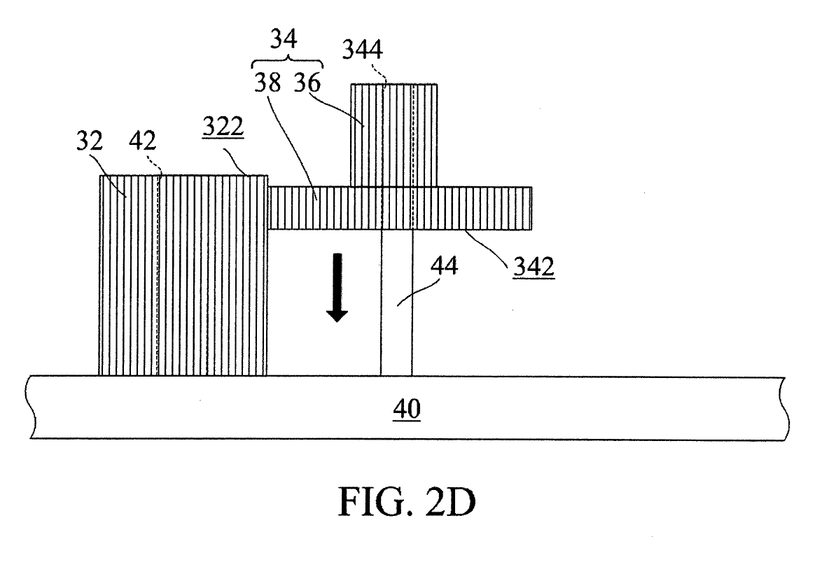

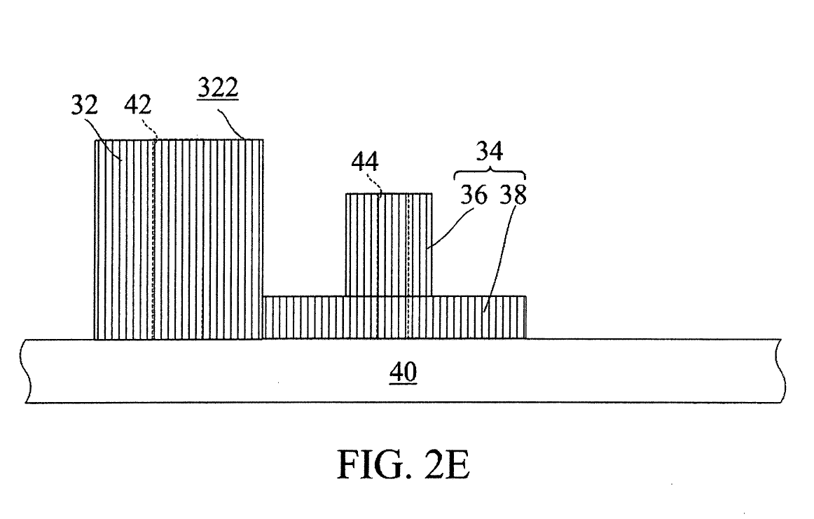

Please refer to FIG. 2A through FIG. 2E, the gear assembly 30 according to one preferred embodiment of the invention and the assembling procedure of the gear assembly are disclosed. As shown in FIG. 2A, the gear assembly 30 according to this invention is assembled onto a plane 40 on which a first shaft 42 and a second shaft 44 are provided. The plane 40 is generally provided by a circuit board if the plane 40 is in an office machine.

The gear assembly 30 according to this invention including a first gear 32 and a second gear 34. Finally, as shown in FIG. 2E, the first gear 32 is rotationally mounted onto the first shaft 42 and the second gear 34 is rotationally mounted onto the second shaft 44. The second gear 34 meshes with the first gear 32.

One characteristic of this invention is that the height of the first gear 32 (h1) is larger than the height of the second shaft (h2), namely, the first gear 32 defines a top surface 322. After the first gear 32 is rotationally mounted onto the first shaft 42, the top surface of the first gear 32 is higher than the second shaft 42 as shown in FIG. 2B.

As shown in FIG. 2A, the second gear 34 defines a bottom surface 342 and has a cylindrical hole 344 adapted to the second shaft 44.

The other characteristic of this invention is that during the assembling process of the gear assembly 30, the mounting procedure of the second gear 34 follows the mounting procedure of the first gear 32. The mounting procedure of the second gear includes the following steps:
(a) Holding the second gear 34 such that the bottom surface 342 of the second gear 34 is over the second shaft 44 as shown in FIG. 2B.
(b) Moving the held second gear 34 forward the mounted first gear 32 such that the second gear 34 partially meshes with the mounted first gear 32, as shown in FIG. 2C.
(c) Adjusting the position of the second gear 34 meshing with the first gear 32 such that the second shaft 44 is inserted into the cylindrical hole 344 of the second gear 34, as shown in FIG. 2D.
(d) Moving the second gear 34 forward the plane 40 to complete the mounting procedure of the second gear 34.

According to the mounting procedure of the second gear 34 described above, before mounting onto the second shaft 44, the second gear 34 partially meshes with the first gear 32. In this way, collisions between the second gear 34 and the first gear 32 can be prevented. Accordingly, the probability of inducing gear teeth cracks is eliminated.

In one embodiment as shown in FIG. 2A, the second gear 34 is a compound gear consisting of an upper gear 36 and a lower gear 38 coaxial with the upper gear 36. The second gear 34 shown in FIG. 2A is a typical compound gear, namely, the outer diameter of the upper gear 36 (d1) is less than the outer diameter of the lower gear 38 (d2). Under this condition, the lower gear 38 provides the bottom surface 342 of the second gear 34 and the second gear 34 partially meshes the first gear 32 by the lower gear 38 in the step (c) of the mounting procedure of the second gear 34. In this embodiment, the height of the first gear 32 (h1) is larger than the sum of the height of the second shaft 44 (h2) and the height of the lower gear 38 (h3).

In one embodiment, the second gear 34 is formed of a polymer material. The first gear 32 is formed of a metal material.

In the other embodiment, the first gear 32 is formed of a polymer material. The second gear 34 is formed of a metal material.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A gear assembly assembled onto a plane, comprising:
a first shaft disposed on the plane;
a first gear mounted onto the first shaft, the first gear defining a top surface;
a second shaft disposed on the plane and closed to the first shaft;
a second gear mounted onto the second shaft and meshing with the first gear, the second gear having a bottom surface and a cylindrical hole adapted to the second shaft; and
wherein after the first gear is mounted onto the first shaft, the top surface of the first gear is higher than the second shaft.

2. The gear assembly of claim 1, wherein the second gear is a compound gear consisting of an upper gear and a lower gear coaxial with the upper gear.

3. The gear assembly of claim 2, wherein an outer diameter of the upper gear is less than an outer diameter of the lower gear.

4. The gear assembly of claim 3, wherein the second gear is formed of a polymer material.

5. The gear assembly of claim 4, wherein the first gear is formed of a metal material.

6. The gear assembly of claim 3, wherein the first gear is formed of a polymer material.

7. The gear assembly of claim 6, wherein the second gear is formed of a metal material.

8. A gear assembly assembled onto a plane on which a first shaft and a second shaft are provided, said gear assembly comprising:
a first gear mounted onto the first shaft, the first gear defining a top surface;
a second gear mounted onto the second shaft and meshing with the first gear; and
wherein after the first gear is mounted onto the first shaft, the top surface of the first gear is higher than the second shaft.

9. The gear assembly of claim 8, wherein the second gear is a compound gear consisting of an upper gear and a lower gear coaxial with the upper gear.

10. The gear assembly of claim 9, wherein an outer diameter of the upper gear is less than an outer diameter of the lower gear.

11. The gear assembly of claim 10, wherein a height of the first gear is higher than the sum of a height of the second shaft and a height of the lower gear.

12. The gear assembly of claim 11, wherein the second gear is formed of a polymer material.

13. The gear assembly of claim 12, wherein the first gear is formed of a metal material.

14. The gear assembly of claim 11, wherein the first gear is formed of a polymer material.

15. The gear assembly of claim 14, wherein the second gear is formed of a metal material.

16. A procedure of assembling a gear assembly onto a plane, said gear assembly comprising a first shaft disposed on the plane, a second shaft disposed on the plane and closed to the first shaft, a first gear defining a top surface, and a second gear defining a bottom surface and having a cylindrical hole adapted to the second shaft, said procedure comprising the steps of:
(a) mounting the first gear onto the first shaft, wherein the top surface of the first gear is higher than the second shaft;
(b) holding the second gear such that the bottom surface of the second gear is over the second shaft;
(c) moving the held second gear forward the mounted first gear such that the second gear partially meshes with the mounted first gear;
(d) adjusting the position of the second gear meshing with the first gear such that the second shaft is inserted into the cylindrical hole of the second gear; and
(e) moving the second gear forward the plane to complete the mounting of the second gear onto the second shaft.

17. The procedure of claim 16, wherein the second gear is a compound gear consisting of an upper gear and a lower gear coaxial with the upper gear.

18. The procedure of claim 17, wherein the lower gear provides the bottom surface of the second gear, and an outer diameter of the upper gear is less than an outer diameter of the lower gear.

19. The procedure of claim 18, wherein in step (c), the second gear via the lower gear thereof partially meshes with the first gear.

20. The procedure of claim 19, wherein a height of the first gear is higher than the sum of a height of the second shaft and a height of the lower gear.
